(19) United States
(12) Patent Application Publication
(10) Pub. No.: US 2014/0270241 A1
(43) Pub. Date: Sep. 18, 2014

(54) METHOD, APPARATUS, AND MANUFACTURE FOR TWO-MICROPHONE ARRAY SPEECH ENHANCEMENT FOR AN AUTOMOTIVE ENVIRONMENT

(71) Applicant: CSR TECHNOLOGY, INC, (US)

(72) Inventors: Tao Yu, Rochester Hills, MI (US); Rogerio G. Alves, Macomb Township, MI (US)

(73) Assignee: CSR TECHNOLOGY, INC, Sunnyvale, CA (US)

(21) Appl. No.: 13/843,254

(22) Filed: Mar. 15, 2013

(51) Int. Cl. G10L 21/0208; H04R 3/00

(52) U.S. Cl. CPC G10L 21/0208; H04R 3/005
USPC 381/86

(57) ABSTRACT

A method, apparatus, and manufacture for speech enhancement in an automotive environment is provided. Signals from first and second microphones of a two-microphone array are decomposed into subbands. At least one signal processing method is performed on the each subband of the decomposed signals to provide a first signal processing output signal and a second signal processing output signal. Subsequently, an acoustic events detection determination is made as to whether the driver, the front passenger, or neither is speaking. An acoustic events detection output signal is provided by selecting the first or second signal processing output signal and by either attenuating the selected signal or not, based on a currently selected operating mode and based on the result of the acoustic events detection determination. Each subband of the acoustics events detection output signal is then combined.

### TECHNICAL FIELD

The invention is related to voice enhancement systems, and in particular, but not exclusively, to a method, apparatus, and manufacture for two-microphone array and two-microphone processing system that supports enhancement for both the driver and the front passenger in an automotive environment.

### BACKGROUND

Voice communications systems have traditionally used single-microphone noise reduction (NR) algorithms to suppress noise and provide optimal audio quality. Such algorithms, which depend on statistical differences between speech and noise, provide effective suppression of stationary noise, particularly where the signal to noise ratio (SNR) is moderate to high. However, the algorithms are less effective where the SNR is very low. Traditional single-microphone NR algorithms do not work effectively in these environments where the noise is dynamic (or non-stationary), e.g., background speech, music, passing vehicles etc.

The restriction of using handheld cell phone while driving created a significant demand for in-vehicle hands-free devices. Moreover, the “Human-Centered” intelligent vehicle requires human-to-machine communications, such as, speech recognition based command and control or GPS navigation for the in-vehicle environment. However, the distance between a hands-free car microphone and the driver will cause a severe loss in speech quality due to changing noisy acoustic environments.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a system;

FIG. 2 shows a block diagram of multiple embodiments of the two-microphone array of FIG. 1;

FIG. 3 illustrates a flowchart of a process that may be employed by an embodiment of the system of FIG. 1;

FIG. 4 shows a functional block diagram of an embodiment of the system of FIG.

FIG. 5 illustrates another functional block diagram of an embodiment of the system of FIG. 1 or FIG. 4;

FIG. 6 illustrates a functional block diagram of an embodiment of the ABF block of FIG. 4;

FIG. 7 shows a functional block diagram of an embodiment of the ADF block of FIG. 4;

FIG. 8 illustrates a functional block diagram of an embodiment of the OMS blocks of FIG. 4; and

FIG. 9 shows a functional block diagram of an embodiment of the system of FIG. 4 in which target ratios for some embodiments of the AED are illustrated, in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “signal” means at least one current, voltage, charge, temperature, data, or other signal.

Briefly stated, the invention is related to a method, apparatus, and manufacture for speech enhancement in an automotive environment. Signals from first and second microphones of a two-microphone array are decomposed into subbands. At least one signal processing method is performed on the each subband of the decomposed signals to provide a first signal processing output signal and a second signal processing output signal. Subsequently, an acoustic events detection determination is made as to whether the driver, the front passenger, or neither is speaking. An acoustic events detection output signal is provided by selecting the first or second signal processing output signal and by either attenuating the selected signal or not, based on a currently selected operating mode and based on the result of the acoustic events detection determination. Each subband of the acoustics events detection output signal is then combined.

FIG. 1 shows a block diagram of an embodiment of system 100. System 100 includes two-microphone array 102, A/D converter(s) 103, processor 104, and memory 105.

In operation, two-microphone array 102 is a two-microphone array in an automotive environment that receives sound via two microphones in two-microphone array 102, and provides microphone signal(s) MAout in response to the received sound. A/D converter(s) 103 converts microphone signal(s) digital microphone signals M.

Processor 104 receives microphone signals M, and, in conjunction with memory 105, performs signal processing algorithms and/or the like to provide output signal D from microphone signals M. Memory 105 may be a processor-readable medium which stores processor-executable code encoded on the processor-readable medium, where the processor-executable code, when executed by processor 104, enable actions to performed in accordance with the processor-executable code. The processor-executable code may enable actions to perform methods such as those discussed in greater detail below, such as, for example, the process discussed with regard to FIG. 3 below.

In some embodiments, system 100 may be configured as two-microphone (2-Mic) hands-free speech enhancement system to provide the clear voice capture (CVC) for both the driver and the front passenger in an automotive environment. System 100 contains two major parts: the two-microphone array configurations of two-microphone array 102 in the vehicle, and two-microphone signal processing algorithms performed by processor 104 based on processor-executable code stored in memory 105. System 100 may be configured to support speech enhancement for both the driver and the front passenger of the vehicle.

Although FIG. 1 illustrates a particular embodiment of system 100, other embodiments may be employed with the scope and spirit of the invention. For example, many more components than shown in FIG. 1 may also be included in system 100 in various embodiments. For example, system 100 may further include a digital-to-analog converter to converter the output signal D to an analog signal. Also, although FIG. 1 depicts an embodiment in which the signal processing algorithms are performed in software, in other embodiments, the signal processing may instead be performed by hardware, or some combination of hardware and/or software. These embodiments and others are within the scope and spirit of the invention.

FIG. 2 shows a block diagram of multiple embodiments of microphone array 202, which may be employed as embodiments of two-microphone array 102 of FIG. 1. Two-microphone array 202 includes two microphones.

The configuration and installation of the 2-Mic array in the car environment is employed for high-quality speech capture and enhancement. For example, three embodiments of two-microphone arrays are illustrated in FIG. 2, each of which may be employed to achieve both higher input signal-to-noise ratio and better algorithm performance, equally in favor of driver and front-passenger.

FIG. 2 illustrates the three embodiments of 2-Mic array configurations, where the 2-Mic array may be installed on the front head-lamp panel, between driver seat and front-passenger seat, in some embodiments. However, other positions for the two-microphone array are also within the scope and spirit of the invention. For example, in some embodiments, the two-microphone array is placed on the back of the head lamp. In other embodiments, the two-microphone array may be installed anyplace on the ceiling roof between (in the middle of) the driver and the front passenger.

In various embodiments, the two microphones of the two-microphone array may be between 1 cm and 30 cm apart from each other. The three 2-Mic array configurations illustrated in FIG. 2 are: two omni-directional microphones, two unidirectional microphones facing back-to-back, and two unidirectional microphones facing side-to-side. Each of these embodiments of arrays is designed to equally capture speech from the driver and the front passenger.

FIG. 2 also illustrates the beampatterns that can be formed and the environmental noise is accordingly reduced as result of the signal processing algorithm(s) performed. The microphone spacing can be different and optimized for each of the configurations. Also, in FIG. 2 only the beampatterns “pointing” to the driver are illustrated; the beampatterns for the front passenger are symmetric to the ones shown in FIG. 2.

FIG. 3 illustrates a flowchart of an embodiment of a process (350) for speech enhancement. After a start block, the process proceeds to block 351, where a user is enabled to select between three modes of operation, including: a mode for enhancing driver speech only, a mode for enhancing front passenger speech only, and a mode for enhancing both driver speech and front passenger speech.

The process then moves to block 352, where two microphone signals, each from a separate one of the microphones from a two-microphone array, are de-composed into a plurality of subbands. The process then advances to block 354, where at least one signal processing method is performed each subband of the decomposed microphone signals to provide a first signal processing output signal and a second signal processing output signal.

The process then proceeds to block 355, where acoustics events detection (AED) is performed. During AED, an AED determination is made as to whether: the driver speaking, the front passenger is speaking, or neither front driver nor the front passenger is speaking (i.e., noise only with no speech). An AED output signal is provided by selecting the first or second signal processing output signal and by either attenuating the selected signal or not, based on the currently selected operating mode and based on the result of the AED determination.

The process then moves to block 356, where the subbands of the AED output signal are combined with each other. The process then advances to a return block, where other processing is resumed.

At block 351, the speech mode selection may be enabled in different ways in different embodiments. For example, in some embodiments, switching between modes could be accomplished by the user pushing a button, indicating a selection in some other manner, or the like.

At block 352, de-composing the signal may be accomplished with an analysis filter bank in some embodiments, which may be employed to decompose the discrete time-domain microphone signals into subbands.

In various embodiments, various signal processing algorithms/methods may be performed at block 354. For example, in some embodiments, as discussed in greater detail below, adaptive beamforming followed by adaptive de-correlation filtering may be performed (for each subband), as well as single-channel noise reduction being performed for each channel after performing the adaptive de-correlation filtering. In some embodiments, only one of adaptive beamforming and adaptive de-correlation is performed, depending on the microphone configuration. Also, the single-channel noise reduction is optional and is not included in some embodiments.

More detail on embodiments of AED performed at block 355 are discussed in greater detail below.

At block 356, in some embodiments, the subbands may be combined to generate a time-domain output signal by means of a synthesis filter bank.

Although a particular embodiment of the invention is discussed above with regard to FIG. 3, many other embodiments are within the scope and spirit of the invention. For example, more steps than those illustrated in FIG. 3 may be performed. For example, in some embodiments, as discussed in greater detail, calibration may be performed on the signal from the microphones prior to performing signal processing. Further, after re-combining the signal at block 356, other steps may be performed, such as converting the digital signal into an analog signal, or the digital signal may be further processed for performing functions such as command and control or GPS navigation in the in-vehicle environment.

FIG. 4 shows a functional block diagram of an embodiment of system 400 for performing signal processing algorithms, which may be employed as an embodiment of system 100 of FIG. 1. System 400 includes microphones Mic_{—}0 and Mic1, calibration block 420, adaptive beamforming (ABF) block 430, adaptive de-correlation filtering (ADF) block 440, OMS blocks 461 and 462, and AED block 470.

In operation, calibration module 420 performs calibration to match the frequency response of the two microphones (Mic_{—}0 and Mic_{—}1). Then, the adaptive beamforming (ABF) module generates two acoustic beams towards the driver and front-passenger, respectively (where the two outputs of adaptive beamforming block 430, the acoustic signals from the driver side and front-passenger side are separated by their spatial direction).

Following the ABF, adaptive de-correlation filter (ADF) module 440 performs ADF to provide further separation of signals from the driver side and front-passenger side. ADF is a blind source separation method. ADF uses statistical correlation to increase the separation between driver and passenger. Depending on the microphones type and distance, either ABF or ADF module may be bypassed/excluded in some embodiments.

Next, the two outputs from the two channels processing modules (ABF and ADF) are processed by a single-channel noise reduction algorithm (NR), referred to as a one microphone solution (OMS) hereafter, to achieve further noise reduction. This single channel noise reduction approach performed by OMS block 461 and OMS block 462 uses the statistical model to achieve speech enhancement. OMS blocks 461 and 462 are optional components that are not included in some embodiments of source 400.

Subsequently, acoustic events detection (AED) module 470 is employed to generate enhanced speech from the driver, the passenger, or both, according to the user-specified settings.

As discussed above, both of ABF block 430 and ADF block 440 are not needed in all embodiments. For example, with the two omni-directional microphone configuration previously discussed, or the configuration with two uni-directional microphones facing side-to-side, the ADF block is not necessary, and may be absent in some embodiments. Similarly, in the configuration with two unidirectional microphones facing back to back, the ABF block is not necessary, and may be absent in some embodiments.

FIG. 5 shows a functional block diagram of an embodiment of a system (500) for performing signal processing algorithms, which may be employed as an embodiment of system 100 of FIG. 1 and/or system 400 of FIG. 4. System 500 includes microphones Mic_{—}1 and Mic_{—}2, analysis filter banks 506, subband 2-Mic Processing blocks 507, and synthesis filter bank 508.

System 500 works in the frequency (or subband) domain; accordingly, an analysis filter bank 506 is used to decompose the discrete time-domain microphone signals into subbands, then for each subband the 2-Mic processing block (507) (Calibration+ABF+ADF+OMS+AED) is employed, and after that a synthesis filter bank (508) is used to generate the time-domain output signal, as illustrated in FIG. 5.

FIG. 6 illustrates a functional block diagram of ABF block 630, which may be employed as an embodiment of ABF block 430 of FIG. 4. ABF block 630 includes beamformer Beam0, beamformer Beam1, phase correction block 631, and phase correction block 632.

Beamforming is a spatially filtering technique that captures signal from a certain direction (or area), while rejecting or attenuating signals from other directions (or areas). Beamforming providing filtering based on the spatial difference between the target signal and noise (or interference).

In ABF block 630, as shown in FIG. 6, two adaptive beamformers Beam0 and Beam1 are used to simultaneously capture speech from driver's direction and front-passenger's direction. In a vector form, we have x=[x₀x₁]^{T}, w₀=[w₀₀,w₀₁]^{T} and [w₁₀,w₁₀]^{T}, and the beamforming output z₀=w₀^{H} and z,=w₁^{H}x contains dominant signals from driver's direction and front-passenger's direction, respectively. In the previous equations, ^{T} and ^{H}, represent transpose and complex conjugate transpose operations respectively; the Phase Correction blocks (631 and 632) shown in FIG. 6 are omitted in the previous equations fir simplicity. The blocks of the functional block diagram shown in FIG. 6 are employed for one subband, but the same function occurs for each subband.

An embodiment of the adaptive beamforming algorithm is discussed below.

Denoting ø as the phase delay factor of the target speech between Mic_{—}0 and Mic_{—}1, and ρ as the cross correlation factor to be optimized, the MVDR solution for the beamformer weights can be written as,

$$w = [ \begin{matrix}{w}_{0} \\ {w}_{1}\end{matrix} ] = \frac{1}{2 - ( {ρe}^{jφ} + {ρ}^{*} {e}^{- jφ} )} [ \begin{matrix}1 - {ρe}^{jφ} \\ - {ρ}^{*} + {e}^{jφ}\end{matrix} ] .$$

The cost function J can be decomposed into two parts, i.e., J=J₁*J₁₁, where J₁ and J₁₁ can be formulated as

$${J}_{I} = {( \frac{1}{2 - ( {ρe}^{jφ} + {ρ}^{*} {e}^{- jφ} )} )}^{′} , \\ {J}_{II} = ( {\vert {x}_{0} \vert}^{2} + {\vert {x}_{1} \vert}^{2} ) * \{ 1 - ( {ρe}^{jφ} + {ρ}^{*} {e}^{- jφ} ) + {ρρ}^{*} \} + {x}_{0} {x}_{1}^{*} \{ - 2 {ρ}^{*} + {e}^{jφ} + {( {ρ}^{*} )}^{2} {e}^{- jφ} \} + {x}_{0}^{*} {x}_{1} \{ - 2 ρ + {e}^{- jφ} + {ρ}^{2} {e}^{jφ} \} .$$

To optimize the cross correlation factor F over the cost functions J₁ and J₁₁, the adaptive steepest descent method can be used. The steepest descent is a gradient-based method used to find the minima of the cost junctions J₁ and J₁₁, and to achieve this goal, the partial derivatives with respect to ρ may be obtained, i.e.:

$$\frac{\partial {J}_{I}}{\partial {ρ}^{*}} = 2 {( \frac{1}{2 - ( {ρe}^{jφ} + {ρ}^{*} {e}^{- jφ} )} )}^{3} {e}^{- jφ} , \\ and , \frac{\partial {J}_{II}}{\partial {ρ}^{*}} = ( {\vert {x}_{0} \vert}^{2} + {\vert {x}_{1} \vert}^{2} ) * \{ - {e}^{- jφ} + ρ \} + {x}_{0} {x}_{1}^{*} \{ - 2 + 2 {ρ}^{*} {e}^{- jφ} \} .$$

Accordingly, using the stochastic updating rule, the optimal cross correlation factor ρ can be iteratively solved as,

$${ρ}^{t + 1} = {ρ}^{t} - {μ}_{ρ}^{t} ( \frac{\partial {J}_{I}}{\partial {ρ}^{*}} {J}_{II} + \frac{\partial {J}_{II}}{\partial {ρ}^{*}} {J}_{I} ) .$$

where μ^{τ}_{φ} is the step-size factor at iteration t.

Accordingly, the 2-Mic beamforming weights can be reconstructed iteratively, by substitution, i.e.:

$${w}^{t + 1} = \frac{1}{2 - ( {ρ}^{t + 1} {e}^{jφ} + {( {ρ}^{t + 1} )}^{*} {e}^{- jφ} )} [ \begin{matrix}1 - {ρ}^{t + 1} {e}^{jφ} \\ - {( {ρ}^{t + 1} )}^{*} + {e}^{jφ}\end{matrix} ] .$$

In some beamforming algorithms, the beamforming output is given by z=w_{H}x, where the estimated target signal can be enhanced without distortion for both amplitude and phase. However, this scheme does not consider the distortion of residual noise, which may cause unpleasant listening effect. This problem becomes severe when the interference noise is also a speech, especially the vowels. From the inventors' observations, some artifacts can be generated at the valley between two nearby harmonics in the residual noise.

Accordingly, in some embodiments, to remedy this problem, the phase from the reference microphone, may be employed as the phase of the beamformer output, i.e,

z=|w^{H}x|exp(j,phase(x_{ref}),

where phase(x_{ref}) denotes the phase from the reference microphone (i.e., Mic_{—}0 for targeting at driver's speech or Mic_{—}1 for targeting at front-passenger's speech).

Accordingly, only the amplitude from the beamformer output is used as amplitude of the final beamforming output; the phase of the final beamforming signal is given by the phase of the reference microphone signal.

FIG. 7 illustrates a functional block diagram of ADF block 740, which may be employed as an embodiment of ADF block 440 of FIG. 4. ADF block 740 includes de-correlation filters a and b.

Some embodiments of ADF block 740 may employ the adaptive de-correlation filtering as described in the published US patent application US 2009/0271187, herein incorporated by reference.

Adaptive de-correlation filtering (ADF) is an adaptive filtering type of blind signal separation algorithm using second-order statistics. This approach employs the correlations between two input channels, and generates the de-correlated signals at the outputs. The use of ADF after ABF can provide further separation of driver's speech and front-passenger's speech. Moreover, with careful system design and adaptation control mechanisms, the algorithm can group several noise sources (interferences) into one output (y₁) and performs reasonably well for the task of noise reduction. FIG. 7 shows the block diagram of ADF algorithm, where a and b are the adaptive de-correlation filters to be optimized in real-time for each subband.

In some embodiments, the de-correlation filter is iteratively updated by the following two equations,

α^{t+1}=μ_{α}^{t}v₁⁺v₀

b^{t+1}=b^{t}+μ_{α}^{t}v₀⁺v₁,

Where μ^{t}_{α} and μ^{t}_{b} are the step-size control factor for de-correlation filters a and b, respectively.

v₀ and v₁ are the intermediate variables and can be computed as,

v₀=z₀−αz₁,

and,

v₁=z₁−bz₀,

The separated output y₀ and y₁ can thus be obtained as,

$${y}_{0} = \frac{1}{1 - ab} {v}_{0} = \frac{1}{1 - ab} ( {z}_{0} - {az}_{1} ) , \\ and , {y}_{1} = \frac{1}{1 - ab} {v}_{1} = \frac{1}{1 - ab} ( {z}_{1} - {bz}_{0} ) .$$

FIG. 8 illustrates a functional block diagram of OMS blocks 861 and 862, which may be employed as embodiments of OMS blocks 461 and 462 of FIG. 4. OMS 461 includes gain block G₀, and OMS 462 includes gain block G₁.

The OMS blocks provide single-channel noise reduction to each subband of each channel. The OMS noise reduction algorithm employs the distinction of statistic models between speech and noise, and accordingly provides another dimension to separate speech from noise. For each channel, a scalar factor called “gain”, G₀ for OMS 461 and G₁ for OMS 462, is applied to each subband of each separate channel, as illustrated in FIG. 8. A separate gain is provided to each subband of each channel, where the gain is a function of the SNR of subband in the channel, so that subbands with a higher SNR have a higher gain, subbands with a lower SNR have a lower gain, and the gain of each subband is from 0 to 1. Some embodiments of OMS block 861 or 862 may employ the noise reduction method as described in the published US patent application US 2009/025434, herein incorporated by reference.

Returning to FIG. 4, AED block 470 is configured to perform the AED algorithm after the OMS processing is employed to each channel. The acoustic events detection (AED) algorithm is designed to classify the input signal into one of three acoustic categories: driver's speech is active, front-passenger's speech is active, and speech is inactive (noise only). After the detection, in some embodiments, specialized speech enhancement strategy can be applied for each of the acoustic events, according to the system settings or modes, as listed in Table 1.

TABLE 1
Speech Enhancement Strategy based on System Modes and Acoustic Events

| | Acoustic Events | | |
|---|---|---|---|
| System Modes | Driver' Speech | Front-passenger' Speech | Noise |
| Only Enhance Driver's Speech | Enhancement | Suppression | Suppression |
| Only Enhance Front-passenger's Speech | Suppression | Enhancement | Suppression |
| Enhance both Driver's Speech and Front- | Enhancement | Enhancement | Suppression |
| passenger's Speech | | | |

A testing statistic is employed, classifying signal into three acoustic events: speech from the driver, speech from the front passenger, and noise only. These three categories are the columns in Table 1. The rows in Table 1 represent the operating mode selected by the user.

The basic element of the testing statistic is the target ratio (TR). For the beamformer 0, the TR can be defined as:

$${TR}_{Beam 0} = \frac{{P}_{{z}_{0}}}{{P}_{{x}_{0}}} ,$$

where P_{z}_{₀}=E{|z₀|²} is the estimated output power of beamformer 0 and Pₓ_{₀}=E{|x₀|²} denotes the estimated input power of microphone 0. This ratio represents the proportion of target signal component in the input. Accordingly, TR is within a range of 0 and 1.

For beamformer 1, the TR can be denoted as:

$${T}_{Seam 1} = \frac{{P}_{{z}_{1}}}{{P}_{{x}_{1}}} ,$$

Similarly, for the ADF block, TR also can be measured as the ratio between its output and input powers, i.e.:

$${TR}_{ADF 0} = \frac{{P}_{{y}_{0}}}{{P}_{{z}_{0}}} , \\ and , {TR}_{ADF 1} = \frac{{P}_{{y}_{1}}}{{P}_{{z}_{1}}} ,$$

Also, considering the complete system and its variants, the combination of TRs from beamforming and ADF algorithms can be obtained, i.e.:

$$TR 0 = \{ \begin{matrix}{TR}_{Beam 0} = \frac{{P}_{{z}_{0}}}{{P}_{{x}_{0}}} , & if ADF is bypassed \\ {TR}_{ADF 0} = \frac{{P}_{{y}_{0}}}{{P}_{{z}_{0}}} , & if Beamforming is bypassed \\ {TR}_{Beam 0} \cdot {TR}_{ADF 0} = \frac{{P}_{{y}_{0}}}{{P}_{{x}_{0}}} , & neither Beamforming or ADF is bypassed\end{matrix} \\ and , TR 1 = \{ \begin{matrix}{TR}_{Beam 1} = \frac{{P}_{{z}_{1}}}{{P}_{{x}_{1}}} , & if ADF is bypassed \\ {TR}_{ADF 1} = \frac{{P}_{{y}_{1}}}{{P}_{{z}_{1}}} , & if Beamforming is bypassed \\ {TR}_{Beam 1} \cdot {TR}_{ADF 1} = \frac{{P}_{{y}_{1}}}{{P}_{{x}_{1}}} , & neither Beamforming or ADF is bypassed\end{matrix}$$

In some embodiments, the target ratios are calculated separate for each subband, but the mean of all of the target ratios is taken and used for TR0 and TR1 in calculating the testing statistic, so that a global decision is made rather than making a separate decision for each subband as to which acoustic event has been detected. And finally, the ultimate testing statistic, denoted by Λ, can be considered as a function of TR0 AND TR1, i.e.:

Λ=f(TR0,TR1).

Some practical functions for f(TR0,TR1) can be chosen as, in various embodiments:

$$f ( TR 0 , TR 1 ) = \{ \begin{matrix}TR 0 - TR 1 \\ log ( TR 0 ) - log ( TR 1 ) \\ {e}^{TR 0} - {e}^{TR 1} .\end{matrix}$$

The testing statistic compares target ratios from the driver's direction and front-passenger's direction; accordingly, it captures the spatial power distribution information. In some embodiments that employ the OMS, a more sophisticated statistic may be used by incorporating the gain from OMS, as

Λ=G₀·G₁·f(TR0,TR1).

Conceptually, some embodiments of the testing statistic contain spatial information (e.g., TR_{Beam}), correlation information (e.g., TR_{ADF}), and statistic model information (e.g., G); and accordingly provide a reliable basis to make an accurate detection/classification decision.

FIG. 9 shows a functional block diagram of an embodiment of system 900, which may be employed as an embodiment of system 400 of FIG. 4. The TRs generated from each of the blocks are shown in FIG. 9.

After defining and computing the testing statistic, as Λ described previously, a simple decision rule can be established by comparing the value of Λ with certain thresholds, i.e.,

Λ≧Th0, Driver's Speech

Th1<Λ<Th0, Noise

Λ≦Th1, Front-Passenger's Speech

where Th0 and Th1 are two pre-defined thresholds. The above decision rule is based on single time-frame statistics, but in other embodiments, some decision smoothing or “hang-over” method based on multiple time-frames may be employed to increase the robustness of the detection.

The output signal from AED, d, is chosen from either one of the two inputs e₀ or e₁, depending on both the AED decision and AED working modes. Moreover, signal enhancement rule listed in Table 1 can be applied. Denoting G_{AED} (G_{AED}<<1) as the suppression gain, Table 2 gives the target signal enhancement strategy, based on AED decision and AED working modes, in accordance with some embodiments.

TABLE 2
AED Output and Suppression

| | Acoustic Events | | |
|---|---|---|---|
| System Modes | Driver' Speech | Front-passenger' Speech | Noise |
| Only Enhance Driver's Speech | Outputₑ_{₀} | Output G_{AED · e}_{₀} | Output\| G_{AED · e}_{₀} |
| Only Enhance Front-passenger's Speech | Output G_{AED · e}_{₁} | Outputₑ_{₁} | Output G_{AED · e}_{₁} |
| Enhance both Driver's Speech and Front- | Outputₑ_{₀} | Outputₑ_{₁} | Output G_{AED · e}_{₀} |
| passenger's Speech | | | |

Accordingly, in some embodiments, system 900 provides an integrated 2-Mic speech enhancement system for in-vehicle environment, in which the differences between target speech and environmental noise are filtered based on three aspects: spatial direction, statistical correlation and statistical model. Not all embodiments employ all three aspects, but some do. System 900 can this can support speech enhancement for driver only, front-passenger only, and both the driver and front-passenger, based on the currently selected system mode. The AED classifies the enhanced signal into three categories: driver's speech, front-passenger's speech, and noise; accordingly, the AED enables system 900 to output signals from pre-selected category(s).

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method for speech enhancement in an automotive environment, comprising:
enabling a user to select between three modes of operation, including: a mode for enhancing driver speech only, a mode for enhancing front passenger speech only, and a mode for enhancing both driver speech and front passenger speech;
receiving: a first microphone signal from a first microphone of a two-microphone array, and a second microphone signal from a second microphone of the two-microphone array;
decomposing the first microphone signal and the second microphone signal into a plurality of subbands;
performing at least one signal processing method on the each subband of the decomposed first and second microphone signals to provide a first signal processing output signal and a second signal processing output signal;
performing an acoustic events detection to make a determination as to whether: the driver is speaking, the front passenger is speaking, or neither front driver nor the front passenger is speaking;
providing an acoustics events detection output signal, wherein providing the acoustics events detection output signal includes:
during the mode for enhancing driver speech only, if the acoustic events detection determination is a determination that the driver is speaking, providing the first signal processing output signal as the acoustic event detection output signal;
during the mode for enhancing driver speech only, if the acoustic events detection determination is a determination that the front passenger is speaking: attenuating the first signal processing output signal, and providing the attenuated first signal processing output signal as the acoustic event detection output signal;
during the mode for enhancing front passenger speech only, if the acoustic events detection determination is a determination that the front passenger is speaking, providing the second signal processing output signal as the acoustic event detection output signal;
during the mode for enhancing front passenger speech only, if the acoustic events detection determination is a determination that the driver is speaking: attenuating the second signal processing output signal, and providing the attenuated second signal processing output signal as the acoustic event detection output signal; and
during the mode for enhancing both driver speech and front passenger speech, if the acoustics event determination is a determination that the driver is speaking or a determination that the front passenger is speaking, providing the first and second signal processing output signals as the acoustic event detection output signal; and
combining each subband of the acoustic event detection output signal.

2. The method of claim 1, wherein decomposing the first microphone signal and the second microphone signal is accomplished with an analysis filter bank, and wherein combining each subband of the acoustic event detection output signal is accomplished with a synthesis filter bank.

3. The method of claim 1, further comprising calibrating the first and second microphone signals.

4. The method of claim 1, wherein
the acoustics event determination is made by comparing a testing statistic to a first threshold and a second threshold, wherein the acoustic event detection determination is a determination that the driver is speaking if the testing statistic exceeds both the first threshold and the second threshold, the determination is that the front passenger is speaking if the testing statistics fails to exceed both the first threshold and the second threshold, and the determination is that neither the driver nor the front passenger is speaking if the testing statistic is between the first threshold and the second threshold, wherein the testing statistic is based, at least in part, on a comparison of a first ratio and a second ratio, wherein the first ratio is the ratio of a power associated with the first processing output signal and a power associated with the first microphone signal, and the second ratio is a ratio of a power associated with the second processing output signal and a power associated with the second microphone signal.

5. The method of claim 1, wherein providing the acoustic event detection output signal further includes:
if the acoustics events determination is a determination that neither the driver nor the front passenger is speaking: attenuating the first signal processing output signal, and providing the attenuated first signal processing output signal as the acoustic event detection output signal.

6. The method of claim 1, wherein the at least one signal processing method includes at least one of adaptive beamforming and adaptive de-correlation filtering.

7. The method of claim 6, wherein the at least one signal processing method further includes noise reduction applied to each channel after performing the at least one of the adaptive beamforming and the adaptive de-correlation filtering.

8. An apparatus for speech enhancement in an automotive environment, comprising:
a memory that is configured to store a plurality of sets of pre-determined beamforming weights, wherein each of the sets of pre-determined beamforming weights has a corresponding integral index number; and
a processor that is configured to execute code that enables actions, including:
enabling a user to select between three modes of operation, including: a mode for enhancing driver speech only, a mode for enhancing front passenger speech only, and a mode for enhancing both driver speech and front passenger speech;
receiving: a first microphone signal from a first microphone of a two-microphone array, and a second microphone signal from a second microphone of the two-microphone array;
decomposing the first microphone signal and the second microphone signal into a plurality of subbands;
performing at least one signal processing method on the each subband of the decomposed first and second microphone signals to provide a first signal processing output signal and a second signal processing output signal;
performing an acoustic events detection to make a determination as to whether: the driver is speaking, the front passenger is speaking, or neither front driver nor the front passenger is speaking;
providing an acoustics events detection output signal, wherein providing the acoustics events detection output signal includes:
during the mode for enhancing driver speech only, if the acoustic events detection determination is a determination that the driver is speaking, providing the first signal processing output signal as the acoustic event detection output signal;
during the mode for enhancing driver speech only, if the acoustic events detection determination is a determination that the front passenger is speaking: attenuating the first signal processing output signal, and providing the attenuated first signal processing output signal as the acoustic event detection output signal;
during the mode for enhancing front passenger speech only, if the acoustic events detection determination is a determination that the front passenger is speaking, providing the second signal processing output signal as the acoustic event detection output signal;
during the mode for enhancing front passenger speech only, if the acoustic events detection determination is a determination that the driver is speaking: attenuating the second signal processing output signal, and providing the attenuated second signal processing output signal as the acoustic event detection output signal; and
during the mode for enhancing both driver speech and front passenger speech, if the acoustics event determination is a determination that the driver is speaking or a determination that the front passenger is speaking, providing the first and second signal processing output signals as the acoustic event detection output signal; and
combining each subband of the acoustic event detection output signal.

9. The apparatus of claim 8, wherein processor is further configured such that the at least one signal processing method includes at least one of adaptive beamforming and adaptive de-correlation filtering.

10. The apparatus of claim 8, further comprising:
the two-microphone array.

11. The apparatus of claim 10, wherein the first microphone of the two-microphone array is an omni-directional microphone, and wherein the second microphone of the two-microphone array is another omni-directional microphone.

12. The apparatus of claim 10, wherein the first microphone of the two-microphone array is an uni-directional microphone, the second microphone of the two-microphone array is another uni-directional microphone, and wherein the first and second microphone are arranged in a side-to-side configuration.

13. The apparatus of claim 10, wherein the first microphone of the two-microphone array is an uni-directional microphone, the second microphone of the two-microphone array is another uni-directional microphone, and wherein the first and second microphone are arranged in a back-to-back configuration.

14. The apparatus of claim 10, wherein a distance from the first microphone to the second microphone is from 1 centimeter to 30 centimeters.

15. The apparatus of claim 10, wherein the two-microphone array is installed on a ceiling roof of an automobile in between positions for a driver and a front passenger.

16. The apparatus of claim 10, wherein the two-microphone array is installed on at least one of a front head lamp panel of an automobile or on a back of the head lamp of the automobile.

17. A tangible processor-readable storage medium that arranged to encode processor-readable code, which, when executed by one or more processors, enables actions for speech enhancement in an automotive environment, comprising:
enabling a user to select between three modes of operation, including: a mode for enhancing driver speech only, a mode for enhancing front passenger speech only, and a mode for enhancing both driver speech and front passenger speech;
receiving: a first microphone signal from a first microphone of a two-microphone array, and a second microphone signal from a second microphone of the two-microphone array;
decomposing the first microphone signal and the second microphone signal into a plurality of subbands;
performing at least one signal processing method on the each subband of the decomposed first and second microphone signals to provide a first signal processing output signal and a second signal processing output signal;
performing an acoustic events detection to make a determination as to whether: the driver is speaking, the front passenger is speaking, or neither front driver nor the front passenger is speaking;
providing an acoustics events detection output signal, wherein providing the acoustics events detection output signal includes:
during the mode for enhancing driver speech only, if the acoustic events detection determination is a determination that the driver is speaking, providing the first signal processing output signal as the acoustic event detection output signal;
during the mode for enhancing driver speech only, if the acoustic events detection determination is a determination that the front passenger is speaking: attenuating the first signal processing output signal, and providing the attenuated first signal processing output signal as the acoustic event detection output signal;
during the mode for enhancing front passenger speech only, if the acoustic events detection determination is a determination that the front passenger is speaking, providing the second signal processing output signal as the acoustic event detection output signal;
during the mode for enhancing front passenger speech only, if the acoustic events detection determination is a determination that the driver is speaking: attenuating the second signal processing output signal, and providing the attenuated second signal processing output signal as the acoustic event detection output signal; and
during the mode for enhancing both driver speech and front passenger speech, if the acoustics event determination is a determination that the driver is speaking or a determination that the front passenger is speaking, providing the first and second signal processing output signals as the acoustic event detection output signal; and
combining each subband of the acoustic event detection output signal.

18. The tangible processor-readable medium of claim 17, wherein the at least one signal processing method includes at least one of adaptive beamforming and adaptive de-correlation filtering.

19. A method for speech enhancement in an automotive environment, comprising:
receiving: a first microphone signal from a first microphone of a two-microphone array, and a second microphone signal from a second microphone of the two-microphone array;
decomposing the first microphone signal and the second microphone signal into a plurality of subbands;
calibrating the first and second microphone signals;
performing at least one signal processing method on the each subband of the decomposed first and second microphone signals to provide a first signal processing output signal and a second signal processing output signal, wherein the signal processing method includes at least one of adaptive beamforming and adaptive de-correlation filtering;
performing an acoustic events detection to make a determination as to whether: the driver is speaking, the front passenger is speaking, or neither front driver nor the front passenger is speaking;
providing an acoustics events detection output signal from first and second signal processing output signals based, at least in part, on a current system mode and the acoustics event detection determination; and
combining each subband of the acoustic event detection output signal.

20. The method of claim 19, wherein the at least one signal processing method further includes noise reduction applied to each channel after performing the at least one of the adaptive beamforming and the adaptive de-correlation filtering.

21. The method of claim 19, wherein the at least one signal processing method includes adaptive beamforming followed by adaptive de-correlation filtering.

22. The method of claim 21, wherein the at least one signal processing method further includes noise reduction applied to each channel after performing the adaptive de-correlation filtering.
